(19) United States
(12) Patent Application Publication
(10) Pub. No.: US 2006/0192768 A1
(43) Pub. Date: Aug. 31, 2006

(54) Remote control device with touch function and method for processing the same

(75) Inventor: Wei-Ming Lee, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/067,546

(22) Filed: Feb. 25, 2005

(51) Int. Cl. G09G 5/00

(52) U.S. Cl. 345/173

(57) ABSTRACT

A remote control device with a touch function and a method for processing the same are proposed which are used for controlling the operation of an electronic device equipped with a receiving unit to receive commands from the remote control device and a displaying unit to communicate with a user. The remote control device includes a keying unit for a user to perform input using keys, wherein the keying unit further includes a character key module for the user to enter required character symbols and a function key module for the user to enter control commands; a touch unit for the user to indicate that a key-in position corresponds to coordinates on a display screen generated by the displaying unit of the electronic device when performing input using the keying unit; a recognition unit for recognizing a signal corresponding to input acquired via the keying unit and an indicating signal acquired from the touch unit; and a transmission unit for transmitting the signal recognized by the recognition unit, such that the electronic device can perform corresponding processes or operations according to the signal. Accordingly, the user is able to conveniently perform input into the electronic device or control the electronic device by the remote control device with a touch function and the method for processing the same.

### FIELD OF THE INVENTION

The present invention relates to a device for performing remote control for an electronic device, and more particularly, to a remote control device with a touch function and a method for processing the same.

### BACKGROUND OF THE INVENTION

Generally speaking, in order to achieve the functions of an electronic device, a certain method is required to operate and control the electronic device. In the case of a computer, conventional operations are achieved by means of input devices connected to the computer such as a keyboard or a mouse. Typically, such devices require that the input devices are constantly connected to the host of the computer via wires, which leads to difficulties in operation or other inconveniences such as imperfect connections and reduced flexibility in terms of equipment layout. Therefore, a wireless connecting method has been provided to address the foregoing prior-art problems.

Recently, wireless input devices have come to market utilizing techniques such as infrared to achieve wireless transmission such as wireless keyboards and wireless mice. In that the connection method is wireless, the drawback of traditional keyboards needing to be “tethered” to the computer with wires can be effectively eliminated.

However, in that text-entry using a keyboard usually has to be made in coordination with an indicating function of a mouse, a wireless keyboard and a wireless mouse used in combination are still inherent with significant drawbacks during practical application. For example, in checking one's e-mail in a windows-based operating system, first, an input field or icon of an e-mail program must be clicked using the mouse. Then, if the user wants to reply to an e-mail, text needs to be keyed in via the keyboard. In other words, a user needs to repeatedly spend a bit of time looking for and activating the input field or icon associated with replying to the e-mail before keying in text via the keyboard, time that adds up over repeated access and time which could be spent more productively otherwise.

Therefore, as computer usage is increasingly ubiquitous in daily life, research has focused on ways to provide a device which is capable of combining text-entry with the indicating function, such that a user can operate a computer using the device more conveniently.

### SUMMARY OF THE INVENTION

In light of the above prior-art drawbacks, a primary objective of the present invention is to provide a remote control device with a touch function and a method for processing the same, so as to combine text-entry with an indicating function.

Another objective of the present invention is to provide a remote control device with a touch function and a method for processing the same, such that a user can operate a computer more conveniently.

In accordance with the above and other objectives, the present invention proposes a remote control device with a touch function and a method for processing the same used to control the operation of an electronic device (such as a computer) equipped with a receiving unit to receive commands from the remote control device and a displaying unit to communicate with a user. The remote control device comprises: a keying unit for a user to perform input using keys, wherein the keying unit further comprises a character key module for the user to enter required character symbols and a function key module for the user to enter control commands; a touch unit for the user to indicate that a key-in position corresponds to coordinates on a display screen generated by the displaying unit of the electronic device when performing input operation using the keying unit; a recognition unit for recognizing a signal corresponding to input acquired via the keying unit and an indicating signal acquired from the touch unit; and a transmission unit for transmitting the signal recognized by the recognition unit, such that the receiving unit of the electronic device can receive the signal. Thus, the electronic device can be operated according to the signal received by the receiving unit.

The present invention also proposes a method for processing a remote control device with a touch function for controlling operation of an electronic device equipped with a receiving unit to receive commands from the remote control device and a displaying unit to communicate with a user, wherein the remote control device comprises a keying unit, a touch unit, and a transmission unit. First, the remote control device serves to determine whether the keying unit or the touch unit has received user input to generate an input signal. Then, when the remote control device determines whether the keying unit or the touch unit has received input, the remote control device serves to recognize the input signal received via the foregoing process and encodes the recognized result prior to passing the encoded signal to the transmission unit. Subsequently, the transmission unit of the remote control device serves to send out the encoded result, such that the receiving unit of the electronic device can receive the encoded signal sent out from the transmission unit of the remote control device. Further, the electronic device performs a decoding process on the encoded signal to decode the encoded signal in order to perform a corresponding process or operation.

Therefore, the user is able to conveniently input data into the electronic device or control the electronic device by the foregoing remote control device with a touch function and the method for processing the same.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram showing the basic construction of a remote control device with a touch function according to the present invention;

FIG. 2a and FIG. 2b are schematic diagrams showing key combinations for the keying unit shown in FIG. 1;

FIG. 3 is a flowchart showing operation of a remote control device 1 with a touch function according to the present invention; and

FIG. 4 is a detailed flowchart showing Step 302 of FIG. 3.

### DETAILED DESCRIPTION OF THE EMBODIMENTS

The present invention is described in the following with specific embodiments, so that one skilled in the pertinent art can easily understand other advantages and effects of the present invention from the disclosure of the invention. The present invention may also be implemented and applied according to other embodiments, and the details may be modified based on different views and applications without departing from the spirit of the invention.

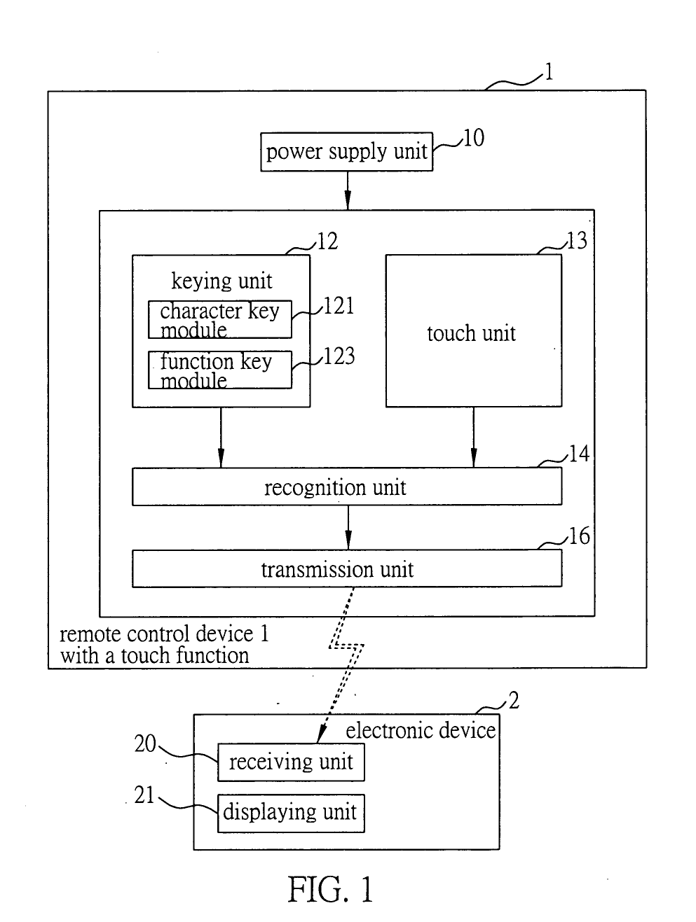

FIG. 1 is a schematic diagram showing the basic construction of a remote control device 1 with a touch function according to the present invention. The remote control device 1 is operated in coordination with an electronic device 2 equipped with a receiving unit 20 and a displaying unit 21. The electronic device 2 can be, for example, a notebook computer or a desktop computer. The remote control device 1 comprises a power supply unit 10, a keying unit 12, a touch unit 13, a recognition unit 14, and a transmission unit 16.

The power supply unit 10 serves to supply power required by the remote control device 1. The keying unit 12 comprising a character key module 121 and a function key module 123 serves to receive signals input by a user and transmit the signals to the recognition unit 14.

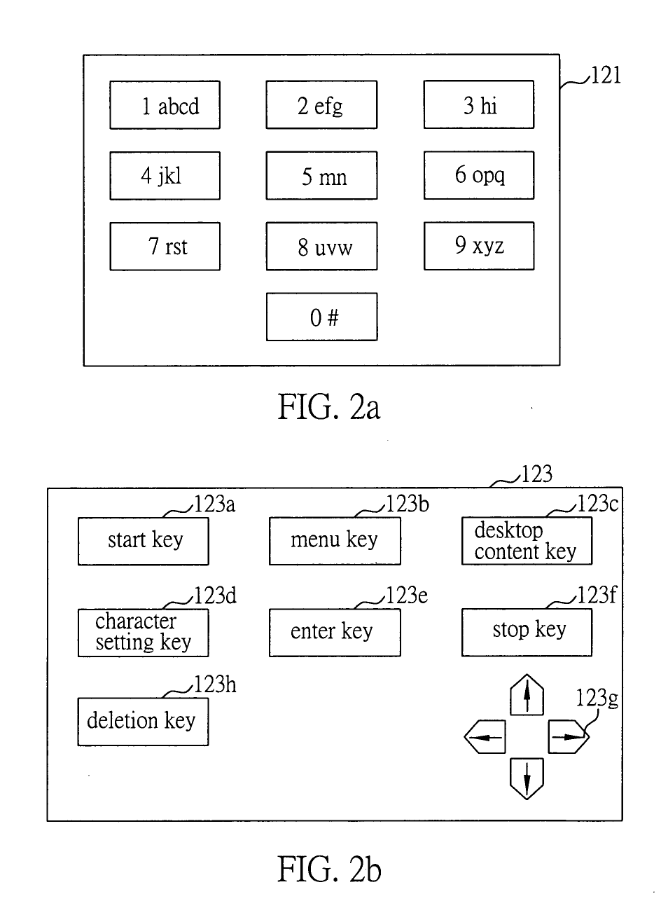

FIG. 2a and FIG. 2b are schematic diagrams showing key combinations of the character key module 121 and the function key module 123 shown in FIG. 1. FIG. 2a shows a plurality of keys provided by the character key module 121 of the remote control device 1. Each of the keys corresponds with two kinds of characters: numbers and letters. Note that the present embodiment is not limited to these keys and that the number of keys can be increased or decreased depending on practical requirements.

FIG. 2b illustrates a plurality of keys provided by the function key module 123 of the remote control device 1. The function key module 123 comprises a start key 123a, a menu key 123b, a desktop content key 123c, a character setting key 123d, an enter key 123e, a stop key 123f, a deletion key 123h, and a shift key 123g. The start key 123a serves to switch on or off the power of the electronic device 2. The menu key 123b serves to enable the displaying unit 21 (such as a liquid crystal display) of the electronic device 2 to display menu contents, such that the user is able to select a desired function, for example, an editing operation from the edit menu of a word processing program. The desktop content key 123c allows the user to enter a screen (for example, the so-called desktop space of a graphical user interface) provided by the displaying unit 21 of the electronic device 2 and select the content shown on the screen, such that the electronic device 2 can be controlled and operated according to the function selected by the user. The character setting key 123d serves to select the type of characters to be entered via the character key module 121, in other words, to choose among English letters or numbers. The enter key 123e (such as the enter key of a computer keyboard) serves to enable the electronic device 2 to operate an operating program provided by the electronic device 2 according to input from the function key module 123 provided by the user. The stop key 123f serves to stop the operation of the specific program of the electronic device 2 which was started according to the input via the foregoing enter key 123e. The deletion key 123h (such as the delete key of a computer keyboard) allows the user to delete selected contents. The shift key 123g allows the user to determine a key-in position for a character or to indicate a position for a control command or the desired position of a cursor.

Referring to FIG. 1, the touch unit 13 is a touch pad. The user can control the electronic device 2 via touch-sensing using the touch unit 13. When the touch unit 13 receives touch signals from the user, the touch signal is transmitted to the recognition unit 14 by the touch unit 13, such that the recognition unit 14 is able to calculate the two-dimensional coordinates of the point touched by the user via the touch unit 13. Furthermore, the coordinates can also correspond with coordinates on a display screen generated by the displaying unit 21 of the electronic device 2, wherein the coordinates on the screen correspond to a desired key-in position indicated by the user using the touch unit for subsequently performing input operation via the keying unit 12. The recognition unit 14 serves to encode the calculated coordinates and transmit the coordinates to the transmission unit 16 which serves to transmit the signals after encoding. In the present embodiment, the signal is transmitted by the transmission unit 16 using the popular infrared light transmission method. However, the signal can also be transmitted by other wireless transmission means such as by transmitting radio waves like those used in the Bluetooth standard. Finally, the signal sent out by the transmission unit 16 is received and decoded by the receiving unit 20 of the electronic device 2 prior to processing by a central processing unit (not shown) of the electronic device 2.

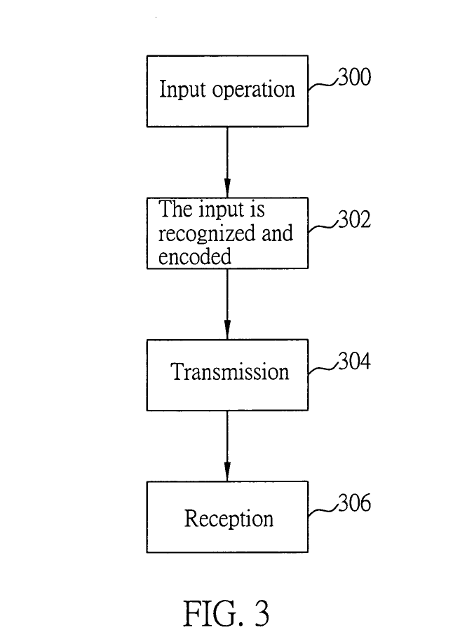

Moreover, FIG. 3 is a flowchart showing operation of the remote control device 1 with a touch function according to the present invention. First, in Step 300, a user performs input operation via the remote control device 1 with a touch function proposed in the present invention. In other words, the user initiates an input operation via the keying unit 12 or the touch unit 13, and then Step 302 is performed.

In Step 302, the recognition unit 14 serves to recognize the input received in the foregoing Step 300. In particular, the recognition unit determines which keyboard key has been pressed or what touch unit coordinates were touched. Then, the recognition unit 14 encodes the recognized result and subsequently passes the encoded result to the transmission unit 16, and then Step 304 is performed.

In Step 304, the transmission unit 16 serves to send out the encoded result obtained in Step 302, and then Step 306 is performed.

In Step 306, the receiving unit 20 of the electronic device 2 serves to receive and decode the encoded signal sent out by the transmission unit 16 of the remote control device 1. Subsequently, the decoded signal is transmitted to the central processing unit (not shown) of the electronic device 2 to be further processed or executed.

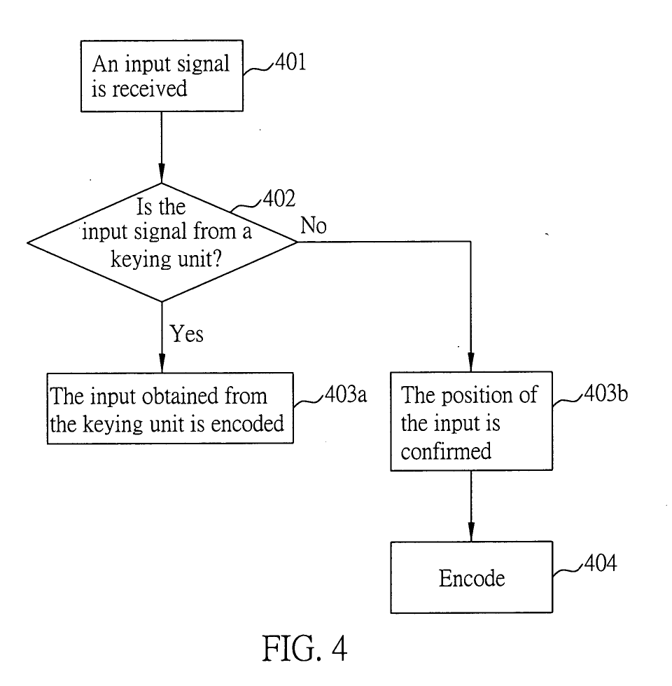

FIG. 4 is a detailed flowchart showing Step 302 of FIG. 3.

First, in Step 401, the input signal from Step 302 is received, and then Step 402 is performed.

In Step 402, it is determined whether the input signal is from the keying unit 12. If the input signal is from the keying unit 12, Step 403a is performed, whereas, if the input signal is not from the keying unit 12, Step 403b is performed instead.

In Step 403a, input from the function key module 123 is encoded in a command format, or input from the character key module 121 is encoded in a text format, thus completing execution of the method if the input was from the keying unit 12.

In Step 403b, the remote control device 1 serves to ascertain the location of a touch position input on the touch unit 13 by the user. The touch position is processed into coordinates in two-dimensional space. Then, Step 404 is performed.

In Step 404, the input command is processed according to the determined result of the touch position obtained in Step 403b and the command is subsequently encoded in a command format.

Because of the remote control device with the touch function and the method for processing the same proposed in the present invention, a user using a computer can directly use the touch function provided by the touch unit of the remote control device. Thus, during a presentation, for example, the presenter doesn't need to repeatedly reach to access the table-bound mouse of the computer to control the presentation. Further, the user can also directly initiate character input using the keying unit of the remote control device without the awkward processing of needing to use the mouse in conjunction with the keyboard in order to input data. Therefore, in comparison to the wireless keyboard of prior-art, the user can operate the computer more conveniently.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A remote control device with a touch function for controlling operation of an electronic device equipped with a receiving unit to receive commands from the remote control device and a displaying unit to communicate with a user, comprising:
a keying unit for the user to perform input into the remote control device via keys of the keying unit, wherein the keying unit comprises a character key module for the user to enter required character symbols and a function key module for the user to enter control commands;
a touch unit for the user to indicate the coordinates of a text-entry position for subsequent text-entry as displayed on a display screen generated by the displaying unit of the electronic device when performing input operation via the keying unit;
a recognition unit for recognizing both a signal corresponding to an input signal acquired via the keying unit and an indicating signal acquired via the touch unit; and
a transmission unit for transmitting the signal recognized by the recognition unit, such that the receiving unit of the electronic device can receive the signal and the electronic device can be operated according to the signal.

2. The remote control device with a touch function of claim 1, wherein character input via keys provided by the character key module is selected from the group consisting of numeric and alphabetic symbols.

3. The remote control device with a touch function of claim 1, wherein the touch unit is a touch pad.

4. The remote control device with a touch function of claim 1, wherein the transmission unit transmits the signal via infrared signals.

5. The remote control device with a touch function of claim 1, wherein the function key module comprises: a starting key for controlling a power status of the electronic device; a menu key for enabling the displaying unit of the electronic device to display menu contents, such that the user is able to select a required function; a desktop content key for entering a screen provided by the displaying unit of the electronic device and selecting the content shown on the screen; a character setting key for setting types of the character symbols to be entered via the character key module; an enter key for enabling the electronic device to operate a predetermined operating program provided by the electronic device according to a key of the function key module selected by the user; a stop key for stopping operation of the predetermined program of the electronic device which was started according to the input via the foregoing enter key; a deletion key for the user to delete selected contents; and a shift key for the user to determine a key-in position for a character or to indicate a position for a control command.

6. The remote control device with a touch function of claim 1, wherein the electronic device is a notebook computer or a desktop computer.

7. A method for processing a remote control device with a touch function for controlling operation of an electronic device equipped with a receiving unit to receive commands from the remote control device and a displaying unit to communicate with a user, wherein the remote control device comprises a keying unit, a touch unit, and a transmission unit, the method comprising steps of:
(1) determining whether the keying unit or the touch unit has been activated by the user to generate an input signal within the remote control device;
(2) recognizing the generated input signal based on the determination of the foregoing step as to whether the user activated the keying unit or the touch unit, encoding the recognized result, and passing the encoded signal to the transmission unit of the remote control device; and
(3) transmitting the encoded result by the transmission unit of the remote control device, after which the receiving unit of the electronic device is able to receive the encoded signal sent out by the transmission unit of the remote control device and then initiate a decoding process to decode the encoded signal in order to subsequently perform a corresponding process or operation.

8. The method for processing the remote control device with a touch function of claim 7, wherein after the remote control device serves to determine whether the keying unit or the touch unit has been activated to generate an input signal, step (2) further comprises the following steps of: encoding the input signal received via the keying unit in a command format if the signal is determined to be a functional signal of the remote control device, and otherwise encoding the input signal received via the keying unit in a text format if the signal is determined to be a character signal of the remote control device.

9. The method for processing the remote control device with a touch function of claim 8, wherein the keying unit is comprised of one type of character keys selected from the group consisting of a plurality of numbers and English letters, such that the character signal input via the keying unit can be generated.

10. The method for processing the remote control device with a touch function of claim 7, wherein step (2) further comprises the following step of: confirming a touch position input in the touch unit by the remote control device when the remote control device determines that the input signal is a signal received via the touch unit, wherein the touch position is confirmed via coordinates in two- dimensional space.

11. The method for processing the remote control device with a touch function of claim 7, wherein the touch unit is a touch pad.

12. The method for processing the remote control device with a touch function of claim 7, wherein the transmission unit transmits the signal via infrared signals.

13. The method for processing the remote control device with a touch function of claim 7, wherein the electronic device is a notebook computer or a desktop computer.
